(19) United States
(12) Patent Application Publication
(10) Pub. No.: US 2004/0048507 A1
(43) Pub. Date: Mar. 11, 2004

(54) Quick-release sensor assembly and method

(76) Inventor: George Hage, Poway, CA (US)

Correspondence Address: GAZDZINSKI & ASSOCIATES, Suite 375, 11440 West Bernardo Court, San Diego, CA, 92127, US

(21) Appl. No.: 10/382,747

(22) Filed: Mar. 5, 2003

Related U.S. Application Data
(60) Provisional application No. 60/362,117, filed on Mar. 5, 2002.

(51) Int. Cl. H01R 13/625

(52) U.S. Cl. 439/332

(57) ABSTRACT

A sensor assembly adapted for rapid removal and replacement of the sensor by the user, as well as enhanced aesthetics and functionality. In one exemplary embodiment, the assembly comprises a camera (e.g., CCD or CMOS) and housing which is removably attached to a support element. The support element is coupled to a mounting surface (e.g., wall, vehicle, etc) via a coupling mechanism which provides a plurality of degrees of freedom. Electrical connections between the camera and support element are made integral with mating surfaces of the camera assembly housing and support element, thereby obviating the need to de-terminate and re-terminate by hand. The support element may also be made universal so as to adapt to a number of different sensor types, thereby allowing the user to rapidly “swap out” sensors of different type as desired. Methods for manufacturing the invention are also disclosed.

### PRIORITY

This application claims priority benefit of U.S. provisional patent application Serial No. 60/362,117 entitled “QUICK-RELEASE SENSOR ASSEMBLY AND METHOD” filed Mar. 5, 2002, which is incorporated by reference herein in its entirety.

### FIELD OF THE INVENTION

The present invention relates generally to sensor and monitoring systems, and specifically to improved apparatus and methods relating thereto, including installing, maintaining, and repairing such systems, and methods for manufacturing the same.

### DESCRIPTION OF RELATED TECHNOLOGY

A variety of different types and configurations of security monitoring and sensor systems are known in the prior art. The following are representative of these different configurations.

U.S. Pat. No. 6,494,425 to Soloway, et al. issued Dec. 17, 2002 and entitled “Apparatus and method of installing an alarm sensor to a corner wall” discloses a security alarm sensor for mounting between two corner walls. The invention comprises a housing unit having a housing base for attachment to the corner walls and a selectively detachable housing cover; a circuit board sized for engagement within the housing unit; first and second openings on opposite sides of the housing base; first and second mounting pins selectively movable within the first and second openings wherein said mounting pins have a length and a range of movement so as to have a first position wherein the mounting pins are totally retracted within the housing unit and a second position wherein said mounting pins extend outwardly from the housing unit sufficiently to pierce the corner walls and securely hold the security alarm sensor in place. The installation of the alarm sensor is usually accomplished by first removing the housing cover from the housing base and detaching the printed circuit board prior to mounting the housing base to the corner of the wall.

U.S. Pat. No. 4,918,473 to Blackshear issued Apr. 17, 1990 and entitled “Surveillance camera system” discloses a surveillance camera system comprising a spherical housing that has a lower, hemispherically shaped, gold coated dome with a geometric center. A camera mount is mounted in the housing for panning movements about a pan axis that extends through the dome center and for tilting movements about a tilt axis that transverses the pan axis through the dome center. Electric motors are mounted in the housing for panning and tilting the camera mount. A video CCD type camera is mounted upon the camera mount with its center of gravity located adjacent the pan and tilt axes. A rotary electric coupler is mounted to the housing and electric connectors provided for connecting the camera and the motors with an ancillary video display and camera orientation controller through the rotary coupler.

U.S. Pat. No. 3,993,866 to Pearl, et al. issued Nov. 23, 1976 and entitled “Camera capsule” discloses a television or film camera attached to an overhead ceiling structure, etc., on a support member which is capable of rotating or panning the camera about a vertical axis and tilting the camera about a horizontal axis. The camera and its movable support structure are enclosed in a stationary housing having a base portion adjacent the ceiling structure and a transparent dome suspended below the base portion. The dome is coated on its inside concave surface with a fine layer of chromium which renders the dome transparent from its relatively dark inside area and opaque or reflective from the lighter area outside the housing. The camera is thus able to assume a large number of positions and focus on various objects in its vicinity about the housing without visual detection from without the housing.

U.S. Pat. No. 4,320,949 to Pagano issued Mar. 23, 1982 and entitled “Weatherized housing assembly for camera” discloses a weatherproof housing assembly for a surveillance camera. The housing has a cover with a skirt over which rainwater may flow, form pendant drops, and fall, and a camera mount adapted to carry a camera and a camera positioning motor. A dome unidirectionally transparent to light is secured to the cover.

U.S. Pat. No. 6,476,856 to Zantos issued Nov. 5, 2002 and entitled “Orbit camera housing” discloses a camera housing permitting installation of a surveillance camera on a wall or ceiling. The camera housing includes tamper resistant features to prevent disabling or vandalism of the camera. Because the camera housing mounts into a wall with a low profile, the camera housing may be installed at eye level to provide a more advantageous viewing angle of an area. For example, the camera housing may be mounted so that the camera is capturing images of a doorway at approximately eye level. This mounting level provides a clearer view of the subject. The camera housing may be positioned so the camera can obtain a view over a range of up to 360 degrees of pan and up to 180 degrees of tilt.

U.S. Pat. No. 6,375,369 to Schneider, et al. issued Apr. 23, 2002 and entitled “Housing for a surveillance camera” discloses a housing assembly permitting the adjustable positioning a surveillance camera enclosed therein. The housing assembly comprises a housing having a cylindrical camera opening therein for receiving the surveillance camera., a camera sled, a detachable lens assembly. The camera sled holds the surveillance camera and is slidably receivable in and rotatable about the longitudinal axis of the camera opening. The camera sled includes positioning means for adjustably fixing the position and orientation of the camera sled assembly within the camera opening. The ballistic lens assembly encloses the camera sled and surveillance camera within the housing. In an alternate embodiment the housing assembly further comprises a pan and tilt mechanism which permits the housing assembly to be manually position within a predetermined range of pan and tilt and acts as a wireway for the camera cabling. The pan and tilt mechanism is reversible and affords protection to camera wiring passing therethrough even when the housing assembly is fully tilted. In another embodiment of the invention, the lens assembly includes a replaceable protective transparent shield for the ballistic lens. The lens and protective shield can be made of ballistic or non-ballistic grade materials.

U.S. Pat. No. 6,354,749 to Pfaffenberger, II issued Mar. 12, 2002 and entitled “Housing for surveillance camera” discloses a housing for a surveillance camera which has an upper housing that is cylindrical and made of steel or the like to withstand ballistic attack. The upper housing houses the pan-and-tilt mechanism, which is suspended from the inside of the upper housing. The camera is carried by the pan-and-tilt mechanism, and extends into a lower, transparent, housing. An inner liner is within the lower housing and covers the camera, the inner liner being made of hardened aluminum or the like to withstand ballistic attack. The inner liner covers the camera, except that a slot allows the camera lens to receive images through the lower housing. A shield is fixed to the camera to move with the camera, covering the slot in the inner liner, the shield defining one opening for the camera lens. The inner liner and the shield are dark in color to prevent visual location of the camera lens, and a polymeric guard physically protects the camera lens.

U.S. Pat. No. 6,015,123 to Perez, et al. issued Jan. 18, 2000 and entitled “Mounting bracket for a camera base” discloses a mounting bracket permits mounting a camera base for a video surveillance camera to a variety of different support structures. The mounting bracket includes first and second outside corner panel sections for defining a concave right-angled structure to selectively be fitted to an outside wall corner, first and second planar panel sections for defining a substantially planar structure to selectively be fitted to a planar wall section, first and second inside corner panel sections for defining a convex right-angled structure to selectively be fitted to an inside wall corner, and first and second attachment panel sections to permit attachment of the camera base to the mounting bracket. The first and second outside corner panel sections are connected to the first and second planar panel sections, respectively, which in turn are connected to the first and second inside corner panel sections, respectively, which in turn are connected to the first and second attachment panel sections, respectively. A securing device is insertable into at least the first and second outside corner panel sections or the first and second planar panel sections or the first and second inside corner panel sections to secure the bracket to a support structure surface.

U.S. Pat. No. 6,093,044 to Arbuckle issued Jul. 25, 2000 and entitled “Quick connect/disconnect mechanism” discloses a latching mechanism for latching the base of a surveillance camera and pan and tilt mechanism within the interior of an electrical receptacle box or housing comprises two components: a latch and a catch. The latch is the dynamic element of the latch mechanism, and is attached to or otherwise formed with the base which supports the pan and tilt mechanism and surveillance camera. The catch forms a part of the receptacle box or housing, and is the static element of the mechanism. The latch mechanism includes a dedicated latch that “latches” onto a dedicated catch of the catch mechanism in the base. The dedicated latch is spring-biased in the direction away from the center of the base and toward the catch mechanism, and also includes a downwardly depending release tab portion that is used for manually releasing the dedicated latch from the dedicated catch by enabling manual biasing of the dedicated latch in the direction toward the center of the base and away from the dedicated catch. Two latch and catch mechanisms are used, diametrically opposed from one another on opposite sides of the base and housing. The dedicated latch and base each include barbed surfaces having slight reverse inclines that cause the dedicated latches to positively engage the respective dedicated catches, under the force of the weight of the base, camera and pan and tilt mechanism, when the base is positively latched within the housing. The electrical receptacle box or housing and the base each include mating electrical connectors that are oriented to self-align and fully interconnect simultaneously with the alignment and mechanical connection of the two latches and catches.

Despite the broad variety of existing solutions for sensor housing and mount configurations (exemplified by the foregoing), there exists a need for a low-cost and easily manipulated solution to interchanging the sensor(s) of a given sensor assembly, such as for maintenance or to install another type of sensor. Specifically, it would be ideal if a configuration were provided which allows simple actuation of a mechanism to completely dissociate the sensor with its support assembly (i.e., “quick disconnect”), and subsequent insertion of a new sensor in its place with similar ease. This solution would ideally also allow as an option the “hot” or energized change-out of the sensor, thereby obviating having to power the assembly down before conducting the replacement operation.

Such improved solution would also optionally allow the use of a substantially “universal” sensor element, wherein substantially identical sensor elements/housings could be used across a number of different installations, thereby significantly reducing on maintenance part inventory burden. This approach would also allow rapid change from one sensor type (e.g., CCD or CMOS camera) to another (e.g., IR sensor).

Such improved solution would also be highly aesthetic, providing a clean and unobtrusive appearance which is substantially devoid of external mechanisms, wiring, connections, and the like.

### SUMMARY OF THE INVENTION

The present invention satisfies the aforementioned needs by providing an improved sensor apparatus and associated methods.

In a first aspect of the invention, an improved sensor assembly is disclosed, generally comprising a support element fixedly mounted to a surface, the support element further comprising at least one electrical conductor; a sensor element having a sensor associated therewith and adapted to mate with the support element, the sensor element being removably coupled to said support element; and at least one electrical interface assembly disposed on the sensor element and said support element such that when the sensor element is mated to said support element, the electrical interface assembly is operable to transfer signals between the sensor and the at least one electrical conductor. In one exemplary embodiment, the sensor comprises a CCD camera, and the electrical interface comprises an electrical contact terminal.

In a second aspect of the invention, a method of manufacturing the aforementioned sensor assembly is disclosed.

In a third aspect of the invention, am improved quick-release sensor assembly is disclosed, generally comprising: a support element comprising at least one electrical conductor; at least one sensor element having a sensor associated therewith and adapted to mate with the support element, the least one sensor element being removably coupled to the support element; and at least one electrical interface assembly disposed on the at least one sensor element and the support element such that when the sensor element is mated to the support element, the electrical interface assembly is operable to transfer signals between the sensor and electrical conductor. In one exemplary embodiment, the sensor element may be removed from the support element via actuation of only a single mechanism.

In a fourth aspect of the invention, a universal sensor assembly is disclosed, generally comprising: a base element adapted for fixed mounting to a supporting object; and a support element coupled to the base element, the support element having a predetermined physical configuration and signal interface, the predetermined configuration and interface being adapted for removable mating to one of a plurality of different complementary sensor element configurations.

In a fifth aspect of the invention, an improved a support structure adapted for supporting at least one sensor is disclosed, the structure generally comprising: a base element adapted to be rigidly affixed to an external source of support; a support element movably coupled to the base element, the movable coupling comprising motion in at least two degrees of freedom; and at least one electrical interface adapted to transfer electrical power to the sensor and signals to and from the sensor; wherein the support element and electrical interface cooperate to allow rapid replacement of the sensor with another.

In a sixth aspect of the invention, a reduced maintenance cost security system having a plurality of discrete sensor assemblies is disclosed. Each of said sensor assemblies generally comprises: a support clement having a standardized size and electrical interface; and a universal sensor element having at least one sensor associated therewith, the universal sensor element being adapted to mechanically and electrically mate in removable fashion with the support element. A common configuration of sensor element may be used in all of the plurality of sensor assemblies.

### BRIEF DESCRIPTION OF THE DRAWINGS

The features, objectives, and advantages of the invention will become more apparent from the detailed description set forth below when taken in conjunction with the drawings, wherein:

FIG. 1 is a front perspective view of a first exemplary embodiment of the sensor assembly according to the present invention, shown fully assembled and installed.

FIG. 2 is a rear perspective view of the sensor assembly of FIG. 1, shown partially disassembled and unmounted.

FIG. 2a is a side partial cross-sectional view of the exemplary snap-fit retaining mechanisms of the present invention.

FIG. 2b is a perspective view of an alternate embodiment of the sensor assembly of the invention, utilizing key-and-slot retaining mechanisms, and circular configuration interface terminals.

FIG. 3 is a front perspective view of the sensor assembly of FIG. 1, shown partially disassembled.

FIG. 3a is a side plan view of one exemplary embodiment of contact terminals used as part of the electrical interface of the sensor assembly of FIGS. 2-3.

FIG. 3b is a top cross-sectional view of the coupling 110 of the sensor assembly of FIG. 1, illustrating the relationship between the support element housing and first coupling segment.

FIG. 3c is a side cross-sectional view of the coupling 110 of the sensor assembly of FIG. 1, illustrating the relationship between first and second coupling segments.

FIG. 4 is a side cross-sectional view of an alternate embodiment of the coupling element of the invention comprising a ball-and-socket arrangement.

FIG. 5 is a side cross-sectional view of an alternate arrangement for coupling the sensor element and support element (or other components) together, comprising a key-and-slot arrangement.

FIG. 6 is a perspective view of another embodiment of the sensor assembly of the invention, including a plurality of sensors utilizing a common support element.

FIG. 7 is a logical flow diagram illustrating one exemplary embodiment of the method of manufacturing the sensor assembly of the present invention.

### DETAILED DESCRIPTION OF THE PREFERRED EMBODIMENT

Reference is now made to the drawings wherein like numerals refer to like parts throughout.

It is noted that while the following description is cast primarily in terms of a camera sensor utilizing one or more charge-coupled devices (CCDs) of the type well known in the electronic arts, cameras or optical viewing devices utilizing other operating principles and technologies (such as CMOS) may be substituted. Additionally, it will be recognized that other types of sensors may be substituted in place of the camera described herein, including without limitation infrared (IR) sensors, ultrasonic emitters/detectors, radio-frequency transmitters/receivers, ionizing radiation detectors, antigen and chemical detection systems, acoustic emitters/detectors, accelerometers, and laser devices. Hence, the term “sensor” as used herein shall be broadly construed to include all such devices.

Furthermore, it will be recognized that the term “camera” as used herein may also include supporting or ancillary components associated with the operation thereof, such as for example a sample-and-hold circuit used to drive a CCD array, data storage device (e.g., RAM/ROM), motorized focal variation drive, or local power supply.

As used herein, “RAM” shall be meant to include, without limitation, SRAM, SDRAM, DRAM, SDRAM, EDR-DRAM. ROM shall be meant to include, without limitation, PROM, EPROM, EEPROM, UV-EPROM.

As used herein, the terms “electrical component” and “electronic component” are used interchangeably and refer to components adapted to provide some electrical function, including without limitation inductive reactors (“choke coils”), transformers, filters, toroid cores, inductors, capacitors, resistors, operational amplifiers, and diodes, whether discrete components or integrated circuits, whether alone or in combination. As used herein, the term “integrated circuit” includes any sort of integrated device including, without limitation, application specific ICs (ASICs), FPGAs, microprocessors, RISC/CISC processors, DSPs, SoC devices, etc.

Sensor Apparatus

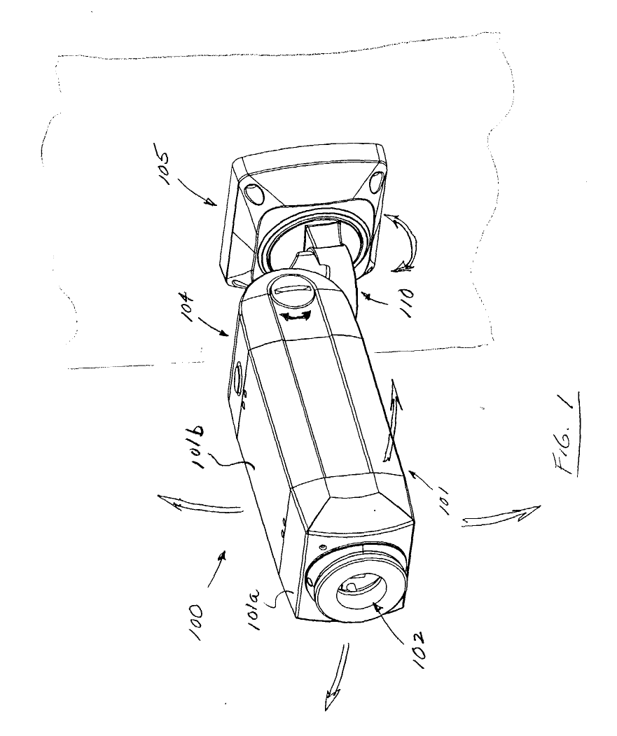

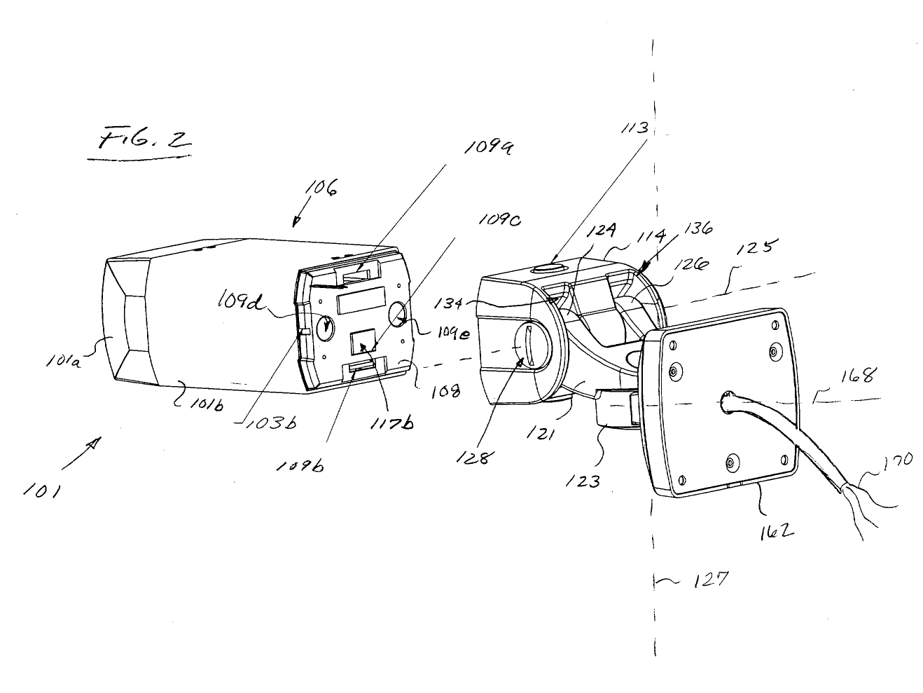

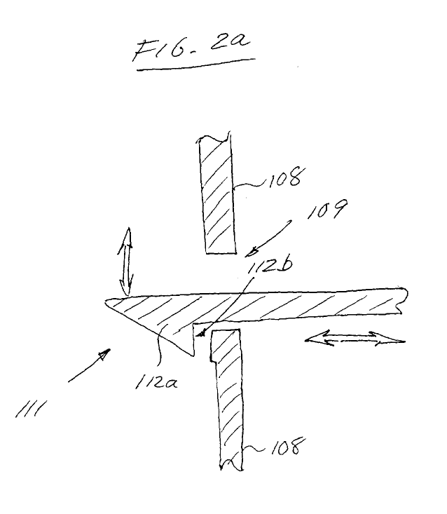

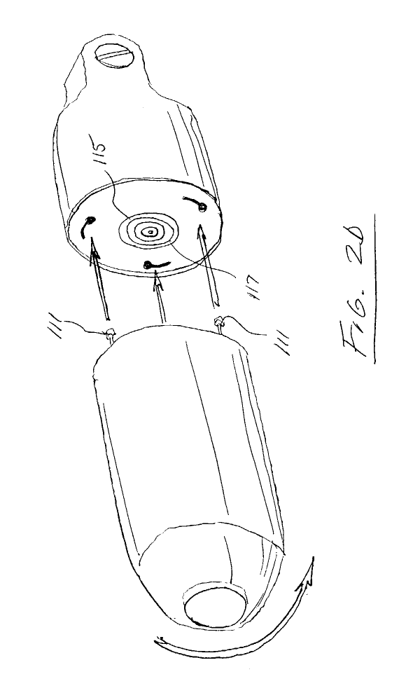

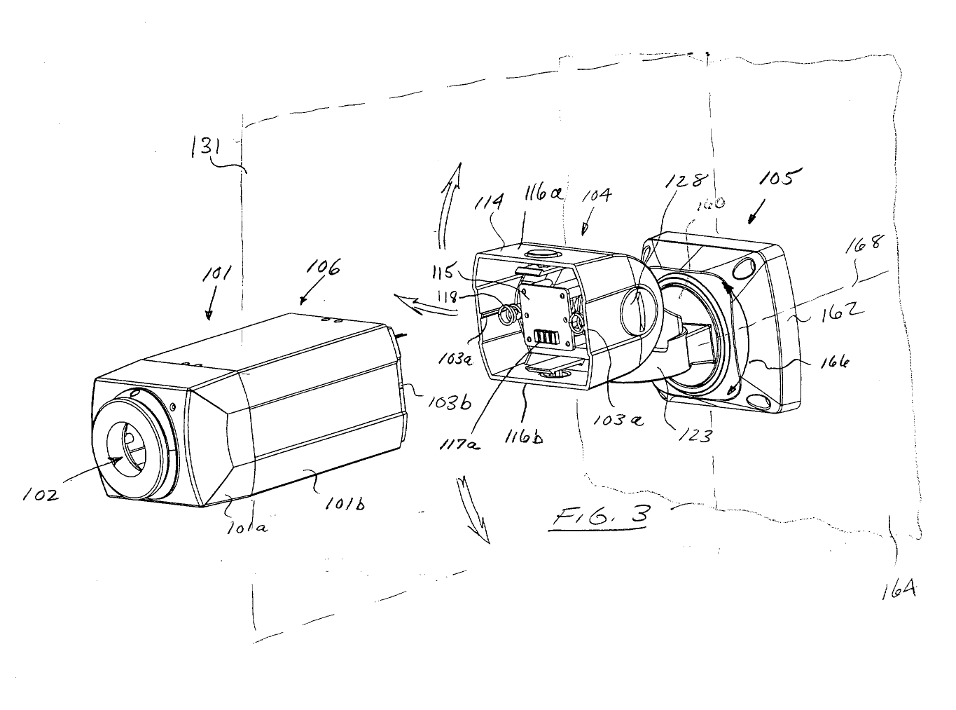

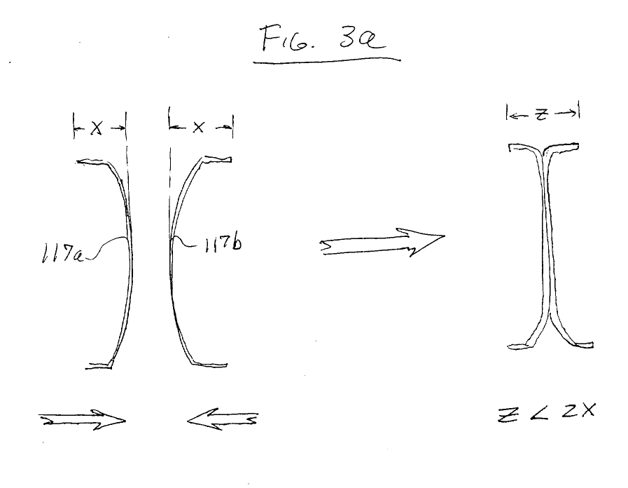

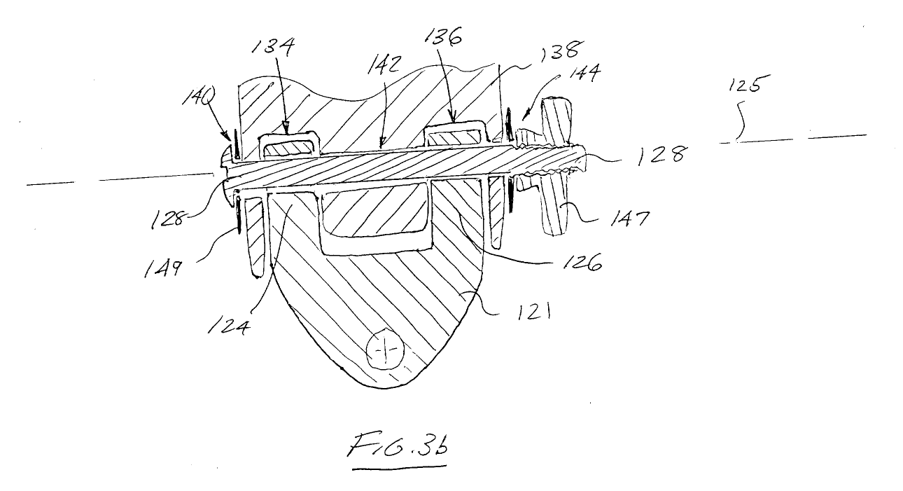

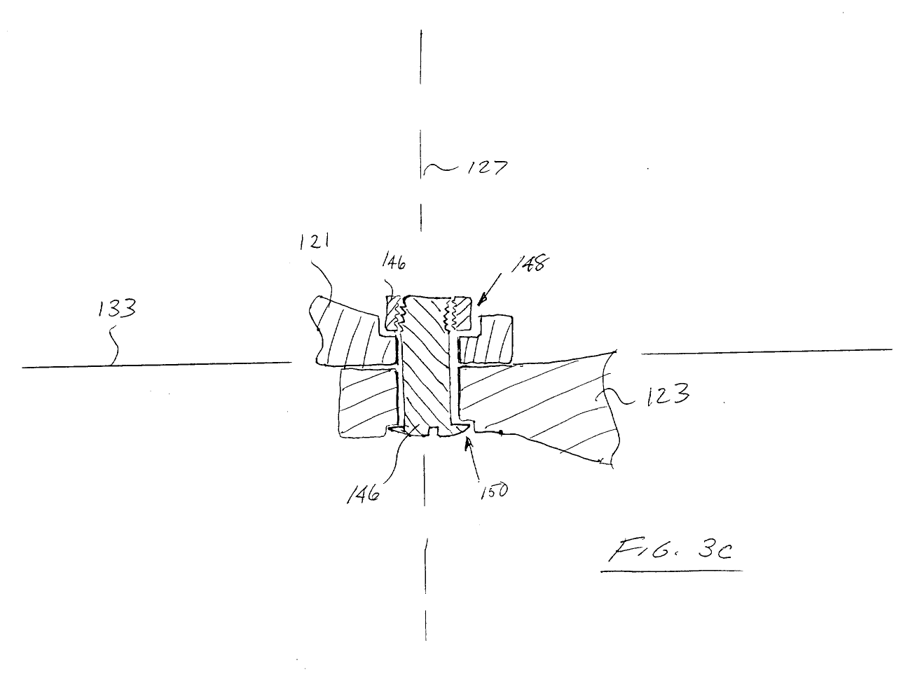

Referring now to FIGS. 1-3, a first exemplary embodiment of the sensor apparatus is described in detail. As shown in FIG. 1, the sensor assembly 100 generally comprises a camera element 101 with integral CCD-based camera 102, a support element 104 rigidly coupled to the camera assembly 101, and a base element 105 movably coupled to the support element 104. The camera element 101 is removably coupled to the support element 104 as shown in FIG. 2 such that the former can be readily removed from the latter by the user. The camera element 101 includes a housing 106 within which the camera 102 (and/or other sensor) is disposed. The housing 106 includes at least one relief element 107a formed at the rear portion of the housing 106 where the camera element 101 mates to the support element 104. In the present embodiment, the relief element 107a comprises a ridge or depressed region as shown best in FIG. 2 which is adapted to fit closely within corresponding interior surfaces 107b of the support element 105. When assembled, the ridge 107a and surfaces 107b cooperate to add mechanical stability and rigidity to the assembly 100. Guide ribs 103a formed in the support element housing 114 (FIG. 3) and corresponding slots 103b formed in the sensor element housing 106 (FIG. 2) provide additional rigidity and alignment between the two components. It will be recognized, however, that these features 107a, 107b are optional, since other means (including the snap fit elements described subsequently herein) may be used to provide all of the required rigidity, mechanical support, and alignment between the sensor element 101 and the support element 104. Furthermore, other types of alignment mechanisms can be employed, such as tapered dowel pins or staking, etc.

It is also noted that the sensor element 101 of FIGS. 1-3 may also be made of two or more subcomponents 101a, 101b, as shown best in FIG. 1. These subcomponents can be adapted to, for example, allow swapping out the sensor with another sensor of the same or different type, changing batteries (if any), performing maintenance of the sensor while installed on the support element 104, etc. In one exemplary embodiment, the first housing subcomponent 101a is made to frictionally “snap” fit into the second, such that the user or technician can conveniently grasp each component in their two hands, and separate them by applying a light but firm force, thereby exposing the camera for the aforementioned maintenance, upgrade, etc. Myriad other configurations are possible, all considered to be encompassed within the present invention.

As shown in FIG. 2, the rear surface 108 of the housing 106 is made generally planar and includes a plurality of apertures 109a-e for a variety of functions, as now described. Two of the apertures 109a, 109b are disposed at the top and bottom of the surface 108, respectively, and receive corresponding ones of retaining devices (e.g., snap fit elements) 111a, 111b, the latter being received into their corresponding apertures 109a, 109b when the sensor element 101 is mated to the support element 104. The snap fit elements, as shown in FIG. 2a, comprise a tapered head region 112a and associated detent 112b adapted to engage a corresponding ridge or raised element (not shown) within the apertures 109a, 109b during assembly. The snap fit elements are, in the present embodiment, made somewhat flexible in the vertical dimension (i.e., in the dimension of an imaginary axis 112c coupling them, as shown in FIG. 2). This is made such because the top and bottom elements 111a, 11b are engaged by respective deflection mechanisms 113 disposed in the top and bottom surfaces 116a, 116b of the housing 114 of the support element 104, these mechanisms altering the vertical position of the head regions 112a thereby allowing selective decoupling of each head region 112a with its corresponding ridge (not shown) in the apertures 109a, 109b as previously discussed.

In the illustrated embodiment, the deflection mechanism comprises a push-button arrangement of the type well known in the mechanical arts, although it will be appreciated that any number of other arrangements may be used. For example, a rotating wing-nut or lever which translates along its axis of rotation (not shown), thereby deflecting the snap fit element 111a could be used. The deflection mechanism in the illustrated embodiment is returned to its normal (non-depressed) position by the aforementioned flexibility and resiliency of the upper snap fit element 111a, the latter being fabricated in the illustrated embodiment from a polymer (e.g., injection molded plastic) which provides the required properties. However, it will be recognized that the housing 114 of the support element 104 may be made of other materials including, for example, lightweight metals or alloys, composites (such as those having a carbon fiber matrix), etc. The housing(s) 106, 114 may also be made heat, water, and/or chemical resistant if desired, such as through the use of special coatings, choice of materials, use of gaskets/o-rings, etc.

Alternatively (or in conjunction), the deflection mechanism may be spring-loaded (not shown) such the button and upper snap fit element 111a are forcibly returned to the normal position by the spring. Myriad other arrangements may be used as desired, all such arrangements being well known to those of ordinary skill.

Furthermore, it will be appreciated that the bottom and/or top snap fit elements 111b, 111a may be configured alone or collectively to provide the desired functionality. Hence, in the illustrated embodiment, the user must depress two buttons (one for the top element 111a, one for the bottom 111b) to remove the sensor element 101 from the support 104. In yet another embodiment, only the top or bottom snap fit element 111 is equipped with a deflection mechanism 113; the other acts in effect as a fulcrum or hinge during assembly, disassembly.

Clearly, other types of retaining devices may be used in place of or in conjunction with the snap-fit elements 111a, 111b described above. For example, the invention may be configured to employ one or more “slot and key” arrangements as shown in FIG. 2b, thereby allowing the user to slide the sensor assembly 101 rotationally with respect to the support element 104 to engage/disengage the keys from their slots. This latter approach has the advantage of obviating the deflection mechanism 113 previously described, although arguably making the acts of mating and un-mating the components somewhat more arduous. Such a configuration also in some circumstances dictates the use of slidably engaging electrical contacts for the electrical interfaces (described in greater detail below).

Referring again to FIG. 3, the internal components of the support element 104 are now described in detail. As shown in FIG. 3, the support element housing 114 further contains a terminal printed circuit board (PCB) 115 mounted in a generally planar configuration parallel to the rear surface 108 of the sensor element housing 106. The PCB contains, inter alia, a plurality of conductive traces, and optionally electrical/electronic components and/or integrated circuits (not shown). The PCB 115 further includes a data/power interface 117. In the exemplary embodiment, this interface comprises a connector assembly 117 having a plurality of conductive terminals 117a adapted to mate with corresponding ones of terminals 117b disposed in the sensor element 101, specifically in aperture 109c as shown best in FIG. 2. These conductive terminals 117 are in the illustrated embodiment contact terminals such that the first terminals 117a on the support element contact corresponding terminals 117b on the sensor element 101 when the two components are assembled. although it will be recognized that literally any type of electrical connection scheme or connector may be used consistent with the design objectives and any prevailing electrical safety standards or considerations. For example, in one alternative, the terminals 117a, 117b may comprise simple exposed, outwardly arched or bowed metallic strips which, when the sensor element 101 and support element are mated, are put into forced communication, the spring-action of the metallic strips maintaining positive contact there between (FIG. 3a). In another alternative, the connector 117 comprises a male-female arrangement, with the female portion being disposed on the support element 104, thereby avoiding having a “hot” protruding power terminal during those periods when the sensor element 101 is removed and the terminals 117a are exposed.

In yet another alternative (not shown), a completely non-contacting interface is provided through use of inductive signal and/or power coupling through adjacent (but non-contacting) inductive terminals. Such inductive data and/or power transfer schemes and circuits are well known to those of ordinary skill in the prior art, and accordingly are not described further herein. As yet another alternative, signals may be transferred across the interface using capacitances induced on the non-contacting terminals. Such non-contacting solutions have the advantage of avoiding direct physical contact, thereby obviating mechanical wear of the contacts/terminals and mitigating the potential for electrical shorting between terminals.

In yet another alternative embodiment, an infra-red (IR) interface is provided, thereby transferring signals across the interface using electromagnetic radiation in the IR range. Such data interfaces are well known in the art, including for example those complying with the IrDA standards. In yet another embodiment, the data interface may comprise a wireless RF interface such as that complying with the “Bluetooth™” wireless interface standard, or alternatively, other so-called “3G” (third generation) communications technologies such as the well known WAP standard. The Bluetooth wireless technology allows users to make wireless and instant connections between various communication devices, such as mobile devices (e.g., the sensor(s) 102 of the sensor element 101) and remote computers or other fixed devices. Since Bluetooth uses radio frequency transmission (2.4 GHz), transfer of data is in real-time. The Bluetooth topology supports both point-to-point and point-to-multipoint connections. Multiple ‘slave’ devices can be set to communicate with a ‘master’ device. In this fashion, the sensor assembly 100 of the present invention, when outfitted with a Bluetooth wireless suite, may communicate directly with other devices including, for example, a remote monitoring device (e.g., computer) adapted to simultaneously monitor data streamed from a plurality of sensor assemblies. In a first exemplary configuration, video data for multiple different cameras within a given security area be simultaneously monitored using a single “master” device adapted to receive and store/display the streamed data received from the various locations. In another configuration, a plurality of heterogeneous sensors (i.e., video, IR, ultrasonic, etc.) disposed at one or more locations can be simultaneously monitored. Or, quite simply, the RF interface can be used to transmit data from the sensor element 101 to the support element 104 (i.e., using a transmitter/receiver pair disposed in the respective elements 101, 104), thereby obviating direct contacting data terminals. A variety of other configurations are also possible. The implementation details of RF and IR data interfaces are well known in the art, and accordingly not described further herein.

The support element housing 114 of the embodiment of FIG. 3 further includes a pair of biasing elements 118 (springs in this embodiment) which are retained within the interior volume of the housing 114 and disposed so as to bias the rear surface 108 of the sensor element housing 106 when the two elements 101, 104 are assembled. The distal ends of the springs 118a, 118b engage corresponding recesses 109d, 109e during assembly to promote proper alignment of the springs 118. The primary function of the springs is to bias the two elements 101, 104 apart, thereby positively engaging the detent 112b of the head portion 112a of each snap fit element against its corresponding portion of the sensor element housing 106; however, the bias force provided by the springs 118 also helps to positively disengage the two housing elements 106, 114 when the push-buttons are depressed and the snap elements released.

Referring again to FIGS. 2 and 3, the coupling 110 disposed between the support element 104 and base element 105 is, in the illustrated embodiment, a pivoting coupling mechanism having two primary segments 121, 123 which allow relative movement of the support element 104 with respect to the base element 105 in multiple dimensions. Specifically, as shown best in FIG. 2, the coupling 110 includes a first axis of rotation 125 and a second axis of rotation 127 disposed relative to the base element 105. In the present embodiment, the first and second axes 125, 127 are disposed in right-angle, orthogonal orientation as shown in FIG. 2 such that the first plane of rotation 131 of the support element 104 with respect to the base 105 is orthogonal with respect to the second plane 133. Hence, the sensor element 101 and associated support element 104 can rotate around the first axis 125, while the camera element, 101, support element 104, and first coupling segment 121 can rotate around the second axis 127 in the second plane 133 which is orthogonal to the first plane 131.

As shown in FIG. 3b, the first segment 121 of the coupling 110 of the present embodiment includes two pivot elements 124, 126 and a (threaded) fastener 128 running longitudinally along the first axis 425 within two corresponding apertures 130, 132 formed in the pivot elements 124, 126, respectively, thereby holding the support element 104 rigidly to the first segment 121. The two pivot elements 124, 126 fit closely within two corresponding recesses 134, 136 formed in the rear portion 138 of the support element 104, thereby allowing the support element 104 to rotate in the first plane 131 smoothly with respect to the pivot elements 124, 126. Three apertures 140, 142, 144 are formed in the rear portion 138 of the support element 104 which also receive the threaded fastener 128 therein. The fastener 128 (with or without load washer(s) 149) is coupled to a nut 147 or alternatively threaded directly into the second pivot element 126, thereby allowing the user to control the level of longitudinal force applied by the fastener 128 to the support element 104 and interposed pivot elements 124, 128. Due to the close coupling of the pivot elements 124, 126 to the sidewalls of their corresponding recesses 134, 136, the level of friction between the two can be controlled by the fastener 128. Hence, in the normal case, the user would tighten the fastener 128 to a level sufficient to prevent relative movement of the support element 104 and the first coupling segment 121 under normal gravitational field. The coupling 110 and fastener 128 are designed such that the moment or torque exerted by said gravitational field on the sensor element 101 can be sufficiently overcome within the acceptable range of retarding frictional force generated between the support element and pivot elements 124, 126 by the fastener 128 operating within its design limits. This criterion prevents the camera/sensor from “drooping” due to gravity.

Alternatively, it will be recognized that the coupling 110 and frictional surfaces of the rear portion 138 of the support element 104 and the pivot elements 124, 126 can be replaced with a splined or toothed arrangement of the type well known in the art, such that the level of force applied by the fastener is effectively decoupled from the resulting level of friction. Using this splined arrangement (not shown), so long as there is at least a minimum level of force exerted by the fastener 128, the relative positions of the pivot elements 124, 126 and the rear portion 138 of the support element 104 will remain constant under the gravitationally-induced torque. This configuration has the added benefit of being relatively insensitive to other potentially relevant environmental and/or material phenomenon including, inter alia, thermal expansion/contraction, humidity, and material “relaxation” or ductility over time when placed under compressive or tensile stress.

Similarly, the first and second segments 121, 123 of the coupling element 110 are joined by a fastener 146 disposed along the second axis 127 within apertures 148, 150 formed in adjacent portions of the first and second segments 121, 123, respectively (FIG. 3c). This arrangement allows relative movement between the first and second segments 121, 123 in the second plane 133 around the second axis 127. As described with respect to the fastener 128 of FIG. 2 above, the fastener 146 of this second joint 152 is configured so as to provide for adjustability by the user, such that the first and second segments 121, 123 can be moved relative to each other when desired, but held fast when no movement is desired, the latter thereby preventing unwanted “drift” during operation.

The coupling segments 121, 123 are also optionally fitted with travel limits or stops (here, simply raised sections designed to frustrate travel of the moving segment 121, 123 beyond a certain arc or position).

Referring again to FIG. 3, the coupling 110 is also optionally fitted with a third joint 154 which permits relative movement of the second coupling segment 123 and its base flange 160 with respect to a base plate 162, the latter being fixedly (to include fixedly removable) attached to a surface 164 such as a wall, ceiling, vehicle panel, etc. using any number of different techniques well known in the art including the illustrated screw arrangement of FIGS. 1-3, adhesives, key-and-slot arrangement, welding/brazing (for metallics), “snap fit” retainers like those previously described herein, etc. The relative movement 166 comprises in the present embodiment rotation movement around an axis 168 disposed normal to the surface 164, although it will be recognized that such axis need not be in any particular orientation. This provides the assembly 100 with yet a third degree of freedom (i.e., rotation around three axes 125, 127, 168), thereby allowing the user to place the assembly in literally any desired orientation with respect to the surface 164. In one embodiment, the joint 154 is made frictional such that rotation around the axis 168 by the second coupling segment (and hence the rest of the assembly 100) is retarded but not completely frustrated. This allows the user to simply firmly grasp the assembly 100 and twist it, using a firmly applied force, thereby obviating adjustment screws, etc. However, it will be recognized that literally any type of arrangement may be utilized for the joint 154, frictional or otherwise. For example, the joint 154 (as well as the others if desired) can be made motor-drive, such that a user can controllably rotate the coupling segment 123 with respect thereto via a remote electrical or wireless control interface.

The coupling 110 of the embodiment of FIGS. 1-3 herein is also adapted to carry one or more electrical conductors 170 (see FIG. 2), whether bundled or segregated. Such conductors may include, for example, data- and power-carrying conductors, wiring associated with motorized drives and/or position-sensors, etc. The conductors 170 in the illustrated embodiment are optimally hidden from direct view by the user when the assembly 100 is mounted to the surface 164, thereby enhancing the aesthetic appeal of the assembly as a whole. This hidden routing is accomplished, inter alia, by providing a series of apertures formed through the support element housing rear portion 138 (not shown), coupling segments 121, 123, base flange 160, and base plate 162.

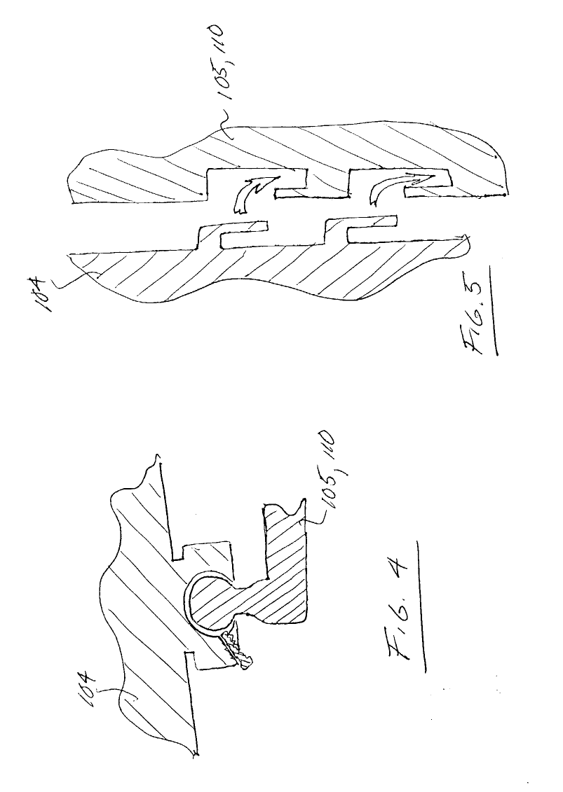

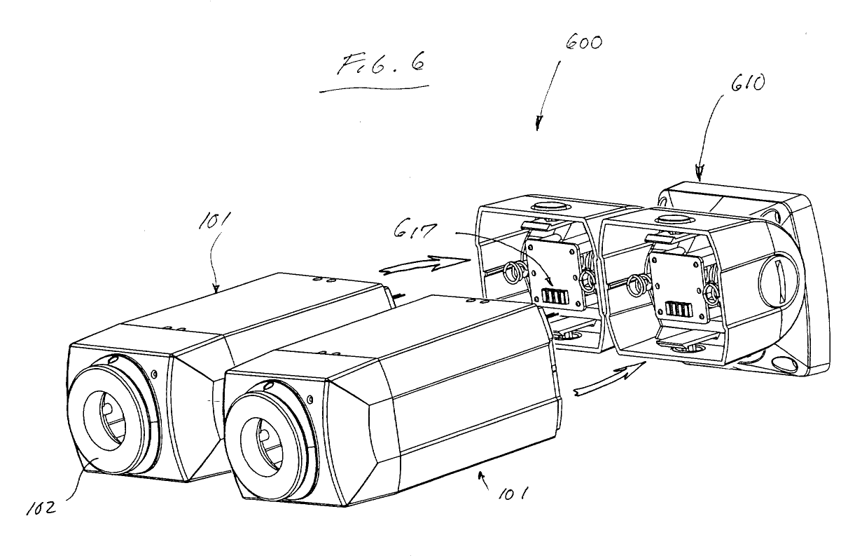

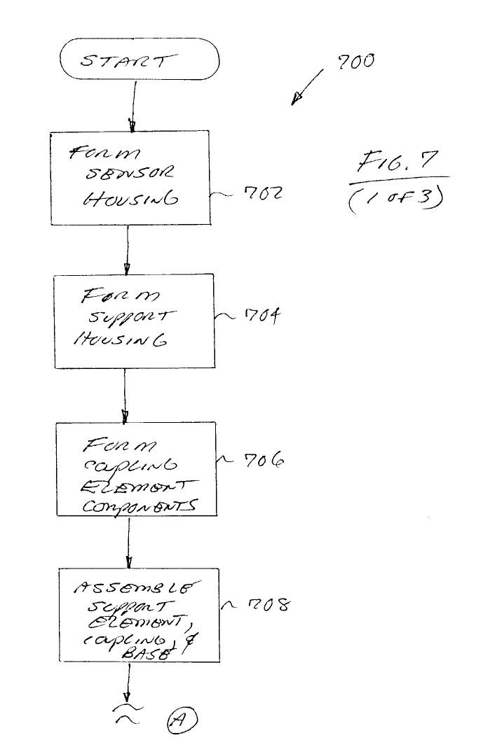

It will also be recognized that any number of other alternative arrangements for coupling the support element 104 to the base element 105 may be utilized consistent with the invention. For example, a single ball-and-socket joint arrangement of the type well known in the mechanical arts (FIG. 4) could be substituted. Alternatively, a plurality of such joints could be employed to provide even more degrees of freedom. As yet another alternative, sliding (e.g., “key and slot” type) couplings as shown in FIG. 5 can be utilized to couple the various components of the assembly 100 together. As yet even a further alternative, a rigid, non-moving mount providing for no relative movement between the sensor (e.g., camera 102) and base element 105 can be utilized if desired. Any number of such alternatives well known to those of ordinary skill in the mechanical arts, whether alone or in combination, may be utilized in the present invention with equal success.

It will be noted that in another advantageous aspect of the invention, the coupling between the sensor element 101 and the support element 104 may be “universal”; i.e., standardized (i) across a given sensor type, and (ii) multiple sensor types, to include the electrical/data interface 117 as well. For example, the support element housing 114 and interface 117a may be made of a particular configuration and size, and the electrical interface specifications complying with for example a prescribed operating voltage, electrical frequency (as applicable), current, and impedance, such that camera elements 101 from any number of distinct manufacturers can be readily fitted to the support element 104. Similarly, the configuration may be made universal across a plurality of different sensor types, thereby allowing what may be a camera mount one minute to be rapidly converted to an infrared (IR) detector the next.

As can be appreciated, use of a “universal” support element 104 has distinct economic advantages as well. Specifically, when the size and configuration of the support element 104 (including placement, size, etc. of any associated electrical interfaces) are standardized, devices from several different manufacturers may be used, thereby allowing the owner of the apparatus to find replacement sensor elements from a number of sources, thereby inherently reducing the market cost of such components. Generally speaking, the more fungible the commodity and the less specialized it is, the lower its equilibrium market cost. Furthermore, in a multi-sensor security or similar system, the cost of maintenance is reduced, since a plurality of different replacement sensor parts are not needed for each different type of sensor installation. The owner may simply stock a lesser number of identical “universal” sensor elements each of which can be fitted to any of the installed universal support elements.

There is also an inherent savings in manpower, since the maintenance person tasked with sensor replacement need not discriminate between or search for the right sensor element for a given installation, since all sensor elements are identical and work equally well. This feature is also available even when multiple different types of sensors are used in a given system. Consider the exemplary security system having one CCD visual band sensor, one CMOS visual band sensor, and one IR sensor disposed at different locations. If a universal support element is utilized, a universal sensor element (housing) will also be used. When the sensor element is configured with separable housing components as previously described herein, the maintenance person may simply insert the desired sensor (i.e., CCD, CMOS, or IR in this example) into the “universal” sensor element housing, and then place the assembled sensor element onto the universal support element.

Furthermore, it will be recognized that the present invention affords the opportunity to change sensor elements while the device is electrically “hot” if desired. Since the assembly is often at an out-of-the-way or elevated location, chances for incidental human contact of exposed conductors (e.g., the electrical interface) are minimal. Furthermore, the electrical interface can be constructed such that the electrified terminals are recessed or substantially inaccessible when the sensor element is removed from the support element, thereby making the chances of such incidental contact even more remote. Safety features such as shutters, gates, etc. which selectively cover the support element electrical interface when the sensor element is removed from the assembly may also be employed if desired, consistent with the invention. Electrical circuitry of the type well known in the art may also be employed to mitigate or eliminate electrical transients resulting from the rather abrupt breaking and making of electrical contact between the sensor element and the support element electrical interface components.

Hence, the user or maintenance person may simply remove the sensor element to be replaced or repaired without having to worry about first de-energizing the entire assembly, which may not be an easily accomplished task, or may necessitate powering off other sensors in the system. This also allows for the use of less skilled labor; instead of requiring someone with significant electrical training needed to secure power to the assembly, the present variant of the invention requires only that the maintenance person know how to actuate the sensor element release mechanism, and insert a new sensor element.

As previously referenced, the present invention may also be configured with one or more motorized mechanisms of the type well known in the art for effecting movement of various components of the assembly 100. For example, motor drives adapted to move the assembly 100 with respect to any of the aforementioned three axes 125, 127, 168 may be used. Additionally, motorization of the focus mechanism of the camera (if so equipped) may be employed. In one embodiment, the user control the camera assembly 100 (or multiple such assemblies from a remote site. The control signal is carried via the cabling 170 previously described (or alternatively, via the wireless interface). Alternatively, a small (e.g., handheld) remote control unit with transmitter adapter located at the monitor side (e.g., where the output from the sensor 102 is being monitored, recorded, etc.) is used. The remote unit may be manually operated (i.e., via a push-button, switch, potentiometer, etc. directly actuated by the operator), or alternatively can be indirectly controlled using, for example, an IR or other wireless interface. In one exemplary embodiment, a specially adapted co-axial cable of the type well known in the art is used to permit carrying the signal from the remote unit at the monitoring location to the sensor assembly 100 with motor drive(s), thereby allowing the operator at the monitoring location to remotely reposition the camera, potentially utilizing the output of the sensor to help with repositioning (such as when the sensor comprises a CCD camera). This approach obviates the user having to perform direct adjustments of the sensor position/focus by hand, which is especially attractive and useful in harsh environments where repeated entry and exposure may be impractical.

The remote (interface) may also be disposed directly at the sensor assembly site, if desired, to allow an operator to adjust the position of the sensor assembly while viewing it directly, such as in the case of a non-optical sensor whose output may not be helpful in pointing the sensor. For example, the remote interface may comprise an IrDA transceiver adapted to receive control signals from the operator's handheld remote unit when the latter is pointed at the IrDA sensor, thereby allowing the user to reposition the sensor without having to physically touch it.

It is also noted that simple and inexpensive motor drive assemblies may be used in conjunction with the present invention, thereby reducing the overall cost of the assembly as compared to prior art solutions.

In yet another embodiment of the invention, the sensor assembly can be configured to include a motor-driven stand-alone “bracket” (not shown) adapted to accept a plurality of different camera or sensor configurations. A user can install the motorized camera bracket to work with any camera available. This bracket can be configured to include the aforementioned remote arrangement thereby allowing the operator to control the sensor position from the remote monitoring site or other location.

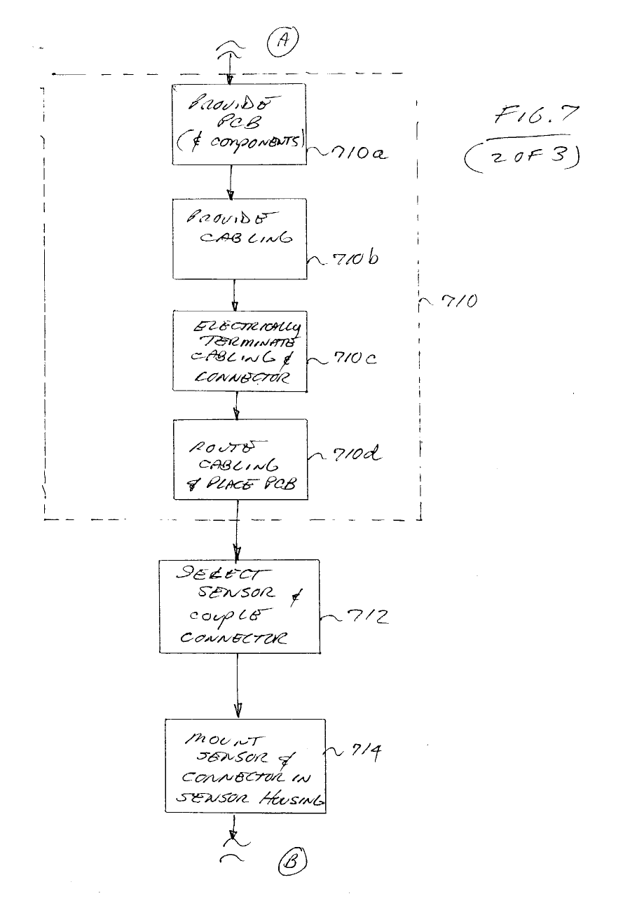

In yet another embodiment of the invention (FIG. 6), the support assembly 104 can be configured to accept a plurality of different sensor element modules 101 simultaneously. For example, in one exemplary configuration, the sensor elements 101 are disposed in side-by-side (1×N) row fashion, thereby forming a 1×N array of sensors 602. This assembly 600 can be adapted such that (i) only one coupling element 610 is utilized (as shown in FIG. 6), or (ii) multiple coupling elements (not shown) are employed to provide individual mobility to each discrete sensor element. Clearly, the sensor elements 101 can be arranged in column format, row-column format, or any other desired configuration. Separate data/power interfaces 617 are provided for each sensor element 101, with all of the cabling 170 for the sensors (and motorized functions) being aggregated through the single base element 605 as previously described.

Method

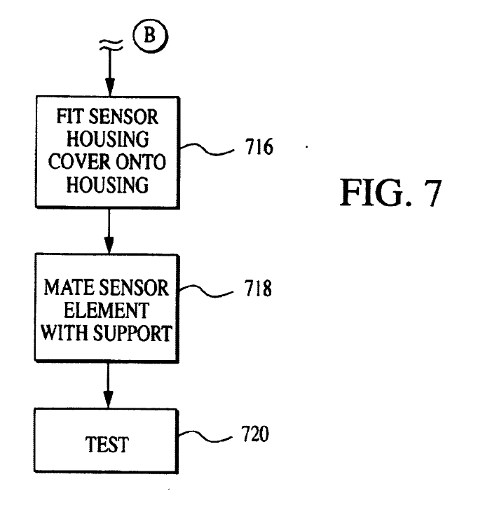

Referring now to FIG. 7, an improved method of manufacturing the apparatus described herein is disclosed. As shown in FIG. 7, the method 700 comprises first forming the sensor element housing 106 (step 702), particularly the constituent portions 101a, 101b. The housing 106 is formed in the illustrated embodiment using well known injection molding techniques, although it will be recognized that other techniques (such as transfer molding, casting, etc.) may be used consistent with the material of choice an the level of detail required, as well as cost considerations.

Next, the support element housing 114 is formed using techniques comparable to those for the sensor housing 106 (step 704). Then, the coupling element 110 and base 105 are fabricated using again the molding techniques previously described (step 706).

The support element 104, coupling 110, and base 105 are then assembled into the configuration shown previously with respect to FIGS. 1-6 (as applicable), using any appropriate hardware (step 708).

The electrical interface 117a and associated components are then selected and installed into the support element housing 114 per step 710. This includes providing the PCB 115 (step 710a), providing the necessary electrical cabling (step 710b), electrically bonding the cabling to the PCB and/or connector 117, such as via a soldering process (step 710c), routing the cabling within the support element 104, coupling 110, and base 105 (step 710d), and then mounting the PCB 115 with connector 117a in the housing 114.

Per step 712, the sensor unit with associated circuitry is next selected and an corresponding electrical interface 117b electrically coupled to that interface 117b. The sensor 102, circuit components, and interface 117b are then mounted within the second sensor housing element 101b (step 714). The first sensor housing element 101a is then fitted over the sensor to form the sensor element 101 as shown in FIG. 1 (step 716).

In step 718, the sensor element 101 is removably mated to the assembled support element 104 as previously described, thereby completing the assembly 100. The device may then be tested if desired (step 720).

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A sensor assembly comprising:
a support element fixedly mounted to a surface, said support element further comprising at least one electrical conductor;
a sensor element having a sensor associated therewith and adapted to mate with said support element, said sensor element being removably coupled to said support element; and
at least one electrical interface assembly disposed on said sensor element and said support element such that when said sensor element is mated to said support element, said electrical interface assembly is operable to transfer signals between said sensor and said at least one electrical conductor.

2. The sensor assembly of claim 1, wherein said support element has a predetermined physical configuration and signal interface, said predetermined configuration and interface being adapted for removable mating to one of a plurality of different complementary sensor element configurations.

3. An adjustable, modular camera assembly comprising:
a coupling element fixedly mounted to a surface and adapted to provide at least two degrees of rotational freedom;
a support element mated to said coupling element, said support element further comprising:
(i) a plurality of electrical conductors; and
(ii) at least one biasing element;
a camera element having at least one camera associated therewith and adapted to mate with said support element, said camera element being removably coupled to said support element via a plurality of retainers, said retainers further comprising at least one deflection element adapted to facilitate said removable coupling, said at least one bias element adapted to bias said camera element from said support element when the two are mated; and
at least one electrical connector assembly having a first portion and a second portion disposed on said sensor element and said support element, respectively, such that when said sensor element is mated to said support element, said first and second portions form an electrical pathway between said sensor and said at least one electrical conductor.

4. A quick-release sensor assembly comprising:
a support element comprising at least one electrical conductor;
at least one sensor element having a sensor associated therewith and adapted to mate with said support element, said at least one sensor element being removably coupled to said support element; and
at least one electrical interface assembly disposed on said at least one sensor element and said support element such that when said at least one sensor element is mated to said support element, said electrical interface assembly is operable to transfer signals between said sensor and said at least one electrical conductor;
wherein said at least one sensor element may be removed from said support element via actuation of at least one mechanism.

5. The sensor assembly of claim 4, wherein said at least one sensor element and support element are biased against one another when mated.

6. The sensor assembly of claim 4, wherein said sensor comprises a charge coupled device (CCD) camera.

7. The sensor assembly of claim 4, wherein said support element and at least one sensor element including corresponding ones of relief elements adapted to increase the rigidity of said assembly when said support and sensor elements are mated.

8. The sensor assembly of claim 4, wherein said at least one sensor element comprises first and second components, said first component being detachable from said second component such that said sensor may be removed from said at least one sensor element when said first and second components are separated.

9. The sensor assembly of claim 4, wherein said at least one mechanism comprises buttons disposed on first and second surfaces of said support element, said first and second surfaces being in substantial opposition to each other.

10. The sensor assembly of claim 4, further comprising a substrate disposed substantially within said support element, at least a portion of said interface assembly being disposed on said substrate.

11. The sensor assembly of claim 4, wherein said interface assembly comprises a non-contacting interface.

12. The sensor assembly of claim 4, further comprising a base element movably coupled to said support element.

13. The sensor assembly of claim 12, wherein said movable coupling comprises at least two degrees of freedom.

14. The sensor assembly of claim 13, wherein said base element may be selectively separated from said support element.

15. The sensor assembly of claim 12, further comprising a motor drive assembly operatively coupled to at least said base element, said motor drive assembly being adapted to reposition said at least one sensor element and support element to a variety of different positions.

16. The sensor assembly of claim 15, further comprising a remote interface adapted to receive wireless commands from a remote unit and actuate said motor drive assembly accordingly.

17. A universal sensor assembly, comprising:
a base element adapted for fixed mounting to a supporting object; and
a support element coupled to said base element, said support element having a predetermined physical configuration and signal interface, said predetermined configuration and interface being adapted for removable mating to one of a plurality of different complementary sensor element configurations.

18. The sensor assembly of claim 17, wherein said removable mating comprises complete physical and electrical separation of said sensor element and said support element solely upon actuation of at least one release mechanism associated with said support element.

19. The sensor assembly of claim 17, wherein at least a portion of said plurality of sensor element configurations comprise a low cost sensor adapted for disposal.

20. A method of producing a sensor assembly adapted for component interchange, comprising:
providing a support element housing;
providing a first sensor element housing component adapted for removable mating to said support element housing;
providing a second sensor element housing component adapted for mating to said first sensor element component;
providing a sensor adapted to be received within both said first and second sensor element housing components;
disposing said sensor at least partly within either said first or second component,
mating said first and second components such that said sensor is captured therein; and
removably mating said sensor element to said support element, thereby forming said sensor assembly.

21. A quick-change sensor assembly adapted to permit removal of a sensor and replacement with another identical or different sensor, comprising:
a sensor element having:
(i) at least one sensor disposed at least partly therein; and
(ii) at least one first electrical interface adapted to transmit electrical power and information signals to and from said at least one sensor; and
a support element adapted to support and removably mate with said sensor element, said support element comprising at least one second electrical interface adapted to transmit electrical power and information signals to and from said at least one first interface;
wherein said at least one first and second electrical interfaces are adapted for rapid separation from each other incident with said removal of said sensor element from said support element.

22. A support structure adapted for supporting at least one sensor, the structure comprising:
a base element adapted to be rigidly affixed to an external source of support;
a support element movably coupled to said base element, said movable coupling comprising motion in at least two degrees of freedom; and
at least one electrical interface adapted to transfer electrical power to said sensor and signals to and from said sensor;
wherein said support element and said at least one electrical interface cooperate to allow rapid replacement of said sensor with another.

23. A reduced maintenance cost security system having a plurality of discrete sensor assemblies, each of said sensor assemblies comprising:
a support element having a standardized size and electrical interface; and
a universal sensor element having at least one sensor associated therewith, said universal sensor element being adapted to mechanically and electrically mate in removable fashion with said support element;
wherein a common configuration of said sensor element may be used in all of said plurality of sensor assemblies.

24. The security system of claim 23, wherein said support element comprises:
a base element adapted to be rigidly affixed to an external source of support,
said support element movably coupled to said base element, said movable coupling comprising motion in at least two degrees of freedom; and
at least one electrical interface adapted to transfer electrical power to said sensor and signals to and from said sensor;
wherein said support element and said at least one electrical interface cooperate to allow rapid replacement of said sensor with another.

25. A method of interchanging sensors in a sensor assembly, comprising:
providing a sensor assembly having a substantially fixed support portion and a removable sensor element mounted thereto;
removing said sensor element from said support portion, said act of removing comprising both physically and electrically separating said sensor element from said support portion concurrently; and
replacing said sensor element with a second replacement sensor element, said act of replacing comprising both physically and electrically mating said second sensor element to said support portion.

26. The method of claim 25, wherein said act of removing and replacing is performed with electrical power applied to electrical terminals disposed within said support portion adapted for mating with corresponding electrical terminals in said sensor element(s).

27. A quick-change sensor assembly comprising:
a support element fixedly yet movably mounted to a surface, said support element further comprising at least one electrical conductor;
a sensor element having a sensor associated therewith and adapted to mate with said support element, said sensor element being removably coupled to said support element; and
at least one electrical interface assembly disposed on said sensor element and said support element such that when said sensor element is mated to said support element, said electrical interface assembly is operable to transfer signals between said sensor and said at least one electrical conductor;
wherein said sensor element is adapted to allow a variety of different types of sensors to be interchanged therein; and
wherein said sensor element and said support element cooperate such that actuation of a mechanism associated therewith permits complete and concurrent physical and electrical dissociation of said sensor element from said support element.
